(19) United States
(12) Patent Application Publication
(10) Pub. No.: US 2025/0337853 A1
(43) Pub. Date: Oct. 30, 2025

(54) INFORMATION PROCESSING APPARATUS, METHOD, STORAGE MEDIUM STORING A PROGRAM, AND PRINTING SYSTEM

(71) Applicant: CANON KABUSHIKI KAISHA, Tokyo (JP)

(72) Inventors: Daisuke Hori, Kanagawa (JP); Yoshinori Kawai, Chiba (JP)

(21) Appl. No.: 19/186,944

(22) Filed: Apr. 23, 2025

(30) Foreign Application Priority Data
Apr. 30, 2024 (JP) 2024-074046

(51) Int. Cl. H04N 1/60; B41J 2/21; B41J 3/46; B41J 11/00; G06F 3/12; H04N 1/00

(52) U.S. Cl. CPC H04N 1/6097; B41J 2/2114; B41J 3/46; B41J 11/0065; B41J 11/008; G06F 3/1208; G06F 3/1252; G06F 3/1256; H04N 1/00413; H04N 1/0044; H04N 1/00474; H04N 1/6019

(57) ABSTRACT

An information processing apparatus, accepts a print setting operation for making a print setting for printing that is based on image data; executes predetermined processing on the image data on the basis of the print setting made by the print setting operation including content indicating that the printing is to be executed using clear ink, the predetermined processing being processing of, among pixels included in the image data, changes at least a pixel value of a pixel corresponding to white, and not changing a pixel value of a pixel included in a margin region provided around the image data and corresponding to white; and sends, to a printing apparatus, a print job for causing the printing apparatus to execute printing that is based on the image data on which the predetermined processing has been executed.

### BACKGROUND

### Field of the Technology

The present disclosure relates to an information processing apparatus, a method, a program, and a printing system capable of controlling printing performed using clear ink.

### Description of the Related Art

Conventional printers such as ink jet printers sometimes print using clear ink (transparent ink) in addition to color ink such as cyan (C), magenta (M), yellow (Y), and black (K) inks. Japanese Patent Laid-Open No. 2012-53626 discloses, as modes in which clear ink is used, a mode in which clear ink is applied to the entire printable region on a printing sheet (a full-surface application mode), and a mode in which clear ink is applied to regions other than white regions within an image region (an automatic application mode).

Recent years have also seen an increase in ink jet printers that use pigment-based inks, which, having pigments as their coloring materials, provide superior weather resistance compared to dye-based inks. With a pigment-based ink, the coloring material is present as particles in a carrier, which makes it difficult for the ink to penetrate to the interior of a printing medium. The coloring material therefore remains on the surface of the printing medium, and as a result, the gloss of the resulting image tends to be somewhat different from the gloss of the printing medium itself. Japanese Patent Laid-Open No. 2011-37015 discloses a technique that reduces such unevenness in gloss by suitably ejecting a clear ink that can form a film to eliminate unevenness in reflected light.

### SUMMARY

The present disclosure provides an information processing apparatus, a method, a storage medium storing a program, and a printing system capable of controlling a range in which clear ink is used in printing.

The present disclosure in its first aspect provides a control method for an information processing apparatus, the control method comprising: accepting a print setting operation for making a print setting for printing that is based on image data; executing predetermined processing on the image data on the basis of the print setting made by the print setting operation including content indicating that the printing is to be executed using clear ink, the predetermined processing being processing of, among pixels included in the image data, changing at least a pixel value of a pixel corresponding to white, and not changing a pixel value of a pixel included in a margin region provided around the image data and corresponding to white; and sending, to a printing apparatus, a print job for causing the printing apparatus to execute printing that is based on the image data on which the predetermined processing has been executed, wherein in a case where the print setting indicated by the print job includes content indicating that the printing is to be executed using clear ink, the printing apparatus applies clear ink to a region corresponding to a pixel indicating white, and does not apply clear ink to a region corresponding to a pixel indicating a color other than white, in a printable region including a region corresponding to the image data and a region corresponding to the margin region.

According to the disclosure, a range in which clear ink is used in printing can be controlled.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are block diagrams illustrating the hardware configuration of a printing system.

FIG. 2 is a diagram illustrating the software configuration of an information processing apparatus.

FIGS. 3A and 3B are diagrams illustrating user interface screens of an application.

FIG. 4 is a diagram illustrating clear ink application modes.

FIG. 5 is a diagram illustrating clear ink application modes.

FIG. 6 is a flowchart illustrating processing performed by the information processing apparatus.

FIG. 7 is a flowchart illustrating processing performed by a printing apparatus.

FIGS. 8A to 8E are diagrams illustrating clear ink application modes.

FIG. 9 is a diagram illustrating an LUT used in a second color conversion process.

FIGS. 10A and 10B are diagrams illustrating an effect of clear ink.

FIGS. 11A to 11C are diagrams illustrating color conversion processing.

FIG. 12 is a diagram illustrating clear ink application modes.

FIG. 13 is a diagram illustrating image processing.

FIG. 14 is a diagram illustrating image processing.

FIGS. 15A and 15B are diagrams illustrating ink separation in a clear ink application mode.

FIGS. 16A to 16D are diagrams illustrating a relationship between ink and light reflection.

FIG. 17 is a diagram illustrating image processing.

FIG. 18 is a flowchart illustrating processing performed by the information processing apparatus.

FIG. 19 is a diagram illustrating the flow of processing performed by each of apparatuses.

FIG. 20 is a diagram illustrating the flow of processing performed by each of apparatuses.

FIGS. 21A to 21C are diagrams illustrating an example of image layouts.

### DESCRIPTION OF THE EMBODIMENTS

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

### First Embodiment

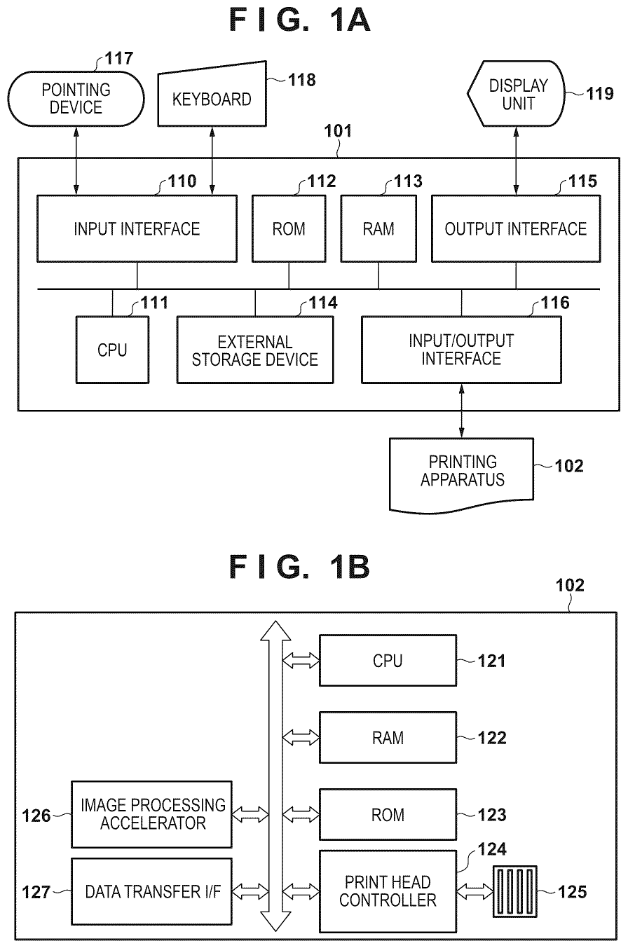

FIG. 1A is a block diagram illustrating the hardware configuration of a printing system. As illustrated in FIG. 1, an information processing apparatus 101 includes an input interface 110, a CPU 111, a ROM 112, a RAM 113, an external storage device 114, an output interface 115, and an input/output interface 116. Input devices such as a keyboard 118, a pointing device 117, and the like are connected to the input interface 110, and a display unit 119 is connected to the output interface 115. The display unit 119 is constituted by a monitor, a panel, and the like, and displays various types of screens. A user interface screen of an application 202 (described later) is displayed in the display unit 119, for example.

An initialization program, for example, is stored in the ROM 112, and various types of data, such as a group of application programs, an operating system (OS), a printer driver, and the like, are stored in the external storage device 114. The RAM 113 may be used as work memory or the like when executing the various types of programs stored in the external storage device 114. Note that in the present embodiment, the CPU 111 implements the operations of the information processing apparatus 101 according to the present embodiment by executing programs stored in the ROM 112. The information processing apparatus 101 may be a personal information terminal such as a Personal Digital Assistant (PDA), a mobile phone, a smartphone, a digital camera, a personal computer (PC), or the like, for example.

A printing apparatus 102 is connected to the information processing apparatus 101 by the input/output interface 116. The printing apparatus 102 and the information processing apparatus 101 may communicate over a wired network, a wireless network, or a network that is a combination thereof. The printing apparatus 102 is an apparatus having a printing function. The printing apparatus 102 may be an MFP having not only a printing function, but also a reading function (a scanner), a fax function, a telephone function, and the like. Note that “MFP” is an acronym for “Multi Function Peripheral”. The present embodiment will describe an ink jet printer capable of ejecting pigment-based color ink and transparent clear ink onto a printing medium as an example of the printing apparatus 102. The following will describe a printing sheet (simply “sheet” hereinafter) as an example of the printing medium.

FIG. 1B is a diagram illustrating the hardware configuration of the printing apparatus 102. In the printing apparatus 102, a CPU 121 controls the printing apparatus 102 as a whole by reading out programs stored in a ROM 123 into a RAM 122, which functions as a work area, and executing those programs. An image processing accelerator 126 is hardware capable of executing image processing faster than the CPU 121. The image processing accelerator 126 is started, for example, by the CPU 121 writing parameters necessary for image processing, and data subject to the image processing, into a predetermined address of the RAM 122. The image processing accelerator 126 loads these parameters and data, and then executes the image processing on that data. However, the image processing accelerator 126 is not an essential element, and equivalent processing may be executed by the CPU 121. The stated parameters may be stored in the ROM 123, or may be stored in storage such as a flash memory, an HDD, or the like (not shown). The image processing executed by the printing apparatus 102 will be described later. A data transfer I/F 127 is an interface for communicating data with the exterior, and has a configuration corresponding to the medium used in an external network (i.e., wireless communication, wired communication, or the like).

After the image processing, print data is transferred to a print head 125 by a print head controller 124. At the same time, through the print head controller 124, the CPU 121 performs control to operate a carriage motor (not shown), which operates the print head 125, as well as to operate a conveyance motor, which conveys the sheet. While scanning above the printing sheet, the print head 125 ejects ink droplets onto the printing sheet on the basis of the print data, and an image is formed as a result. The print head 125 is configured to be capable of ejecting ink corresponding to, for example, cyan (C), magenta (M), yellow (Y), and black (K) colors, as well as transparent ink.

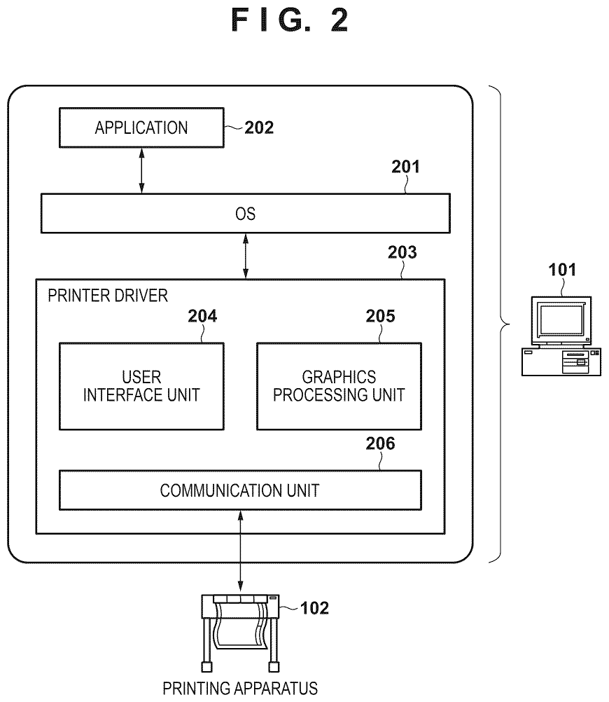

FIG. 2 is a diagram illustrating the software configuration of the information processing apparatus 101. The following will describe an example in which Windows is installed as an operating system (OS) 201.

The application 202 is software for generating image data to be printed by the printing apparatus 102. A user can adjust the layout, perform various types of editing tasks, and the like in screens displayed by the application 202, and the image data is generated as a result. When adjusting the layout, performing various types of editing tasks, and the like in the screens displayed by the application 202, the user makes various types of print settings in a printer driver 203 provided by the vendor of the printing apparatus 102. A screen for making the print settings (a print settings screen) is displayed by a user interface unit 204 called from the application 202 through the OS 201. The user can make various types of print settings necessary for printing, such as specifying the type of the sheet, the size of the sheet, and the like, in the print settings screen. Note that by using a function of the OS 201, such as Print Ticket or Print Capabilities, the application 202 may be capable of accepting print setting instructions from the user directly in the screen of the application 202, without the print settings screen being displayed.

After the print settings made in the print settings screen are complete, the user instructs the application 202 to execute the print by pressing a “print” button on the screen of the application 202. Upon receiving the instruction to print from the user, the application 202 generates image data and passes that image data to a graphics processing unit 205 of the printer driver 203 through the OS 201.

The graphics processing unit 205 performs color conversion processing (described later) on the image data, and then converts the image data into a data format that can be interpreted by the printing apparatus 102. The conversion processing performed on the image data will be described later. A print job containing the image data converted into a data format that can be interpreted by the printing apparatus 102, print setting information pertaining to the various print settings, and print commands is sent to the printing apparatus 102 through a communication unit 206. Then, in the printing apparatus 102, ink is ejected from the print head 125 onto a sheet that is fed, and an image is formed thereon. Note that the print commands include, for example, instruction commands for causing the printing apparatus 102 to print on the basis of the print settings information (described later).

Although a printing method which uses the printer driver 203 has been described above, the configuration may be such that the application 202 sends the print job to the printing apparatus 102 directly through the input/output interface 116, rather than through the printer driver 203. In other words, the application 202 may also perform the aforementioned color conversion processing, and the processing for conversion into a data format that can be interpreted by the printing apparatus 102.

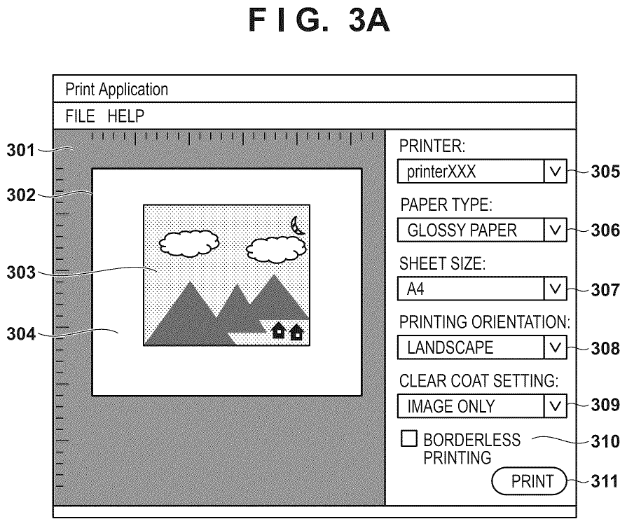

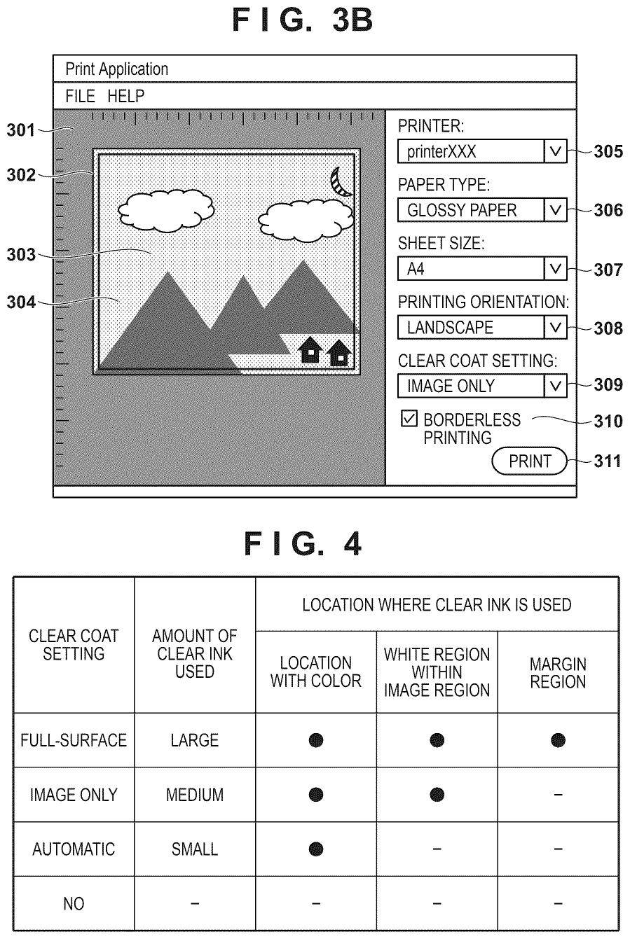

FIGS. 3A and 3B are diagrams illustrating an example of screens of the application 202. The user can adjust the layout, perform various types of editing tasks, and the like on an image to be printed, displayed in the screen of the application 202, and image data is generated as a result. Note that methods for specifying the data to be processed by the application 202 include, for example, a method in which the user opens File Explorer from a “File” menu of the application 202 and specifies the data, a method in which the user inputs the data by dragging and dropping an icon corresponding to the data into the screen of the application 202, and the like. The data may be in any format that can be interpreted by the application 202, such as Bitmap, Tiff, or the like, for example. The data may also be in a vector format, such as XML Paper Specification (XPS), Enhanced Metafile (EMF), or the like.

In the application 202, borderless printing can be enabled or disabled as one of the print settings. FIG. 3A illustrates the screen when borderless printing is disabled due to a check box in a “borderless printing” setting 310 not being checked.

A preview region 301 is a region in which a sheet region 302, an image 303 laid out by the user, and the like are displayed. In the screen illustrated in FIG. 3A, the “borderless printing” setting 310 is disabled, and the user can therefore use a pointing device or the like, for example, to directly manipulate the size, position, and the like of the image 303 in the sheet region 302 (e.g., resizing, repositioning, and the like). A margin region 304 is a region obtained by excluding, from the sheet region 302, an image region corresponding to the image displayed as the image 303, and will also be called a “border region”. In other words, the user can provide the border region by disabling borderless printing, and FIG. 3A illustrates a case where the border region is provided. Note that in the present embodiment, a region corresponding to an image displayed in the screen on the basis of image data, or an image printed on a sheet on the basis of image data, will be called an “image region”. As such, the margin region and the border region are regions different from the image region.

A “printer” setting 305 is an item for accepting a designation of the printer driver 203 to be used for printing. A “paper type” setting 306 is a setting item for accepting a designation of the type of paper to be used for printing. A “paper size” setting 307 is a setting item for accepting a designation of the size of the paper to be used for printing. A “printing orientation” setting 308 is a setting item for accepting a designation of the orientation of the printing. By using a function of the OS, such as Print Capabilities, the application 202 can obtain, from the printing apparatus 102, information indicating the capabilities that can be set (displayed as options) through the “paper type” setting 306, the “paper size” setting 307, and the “printing orientation” setting 308, for the printer driver 203 selected by the user in the “printer” setting 305. The application 202 determines the size, orientation, and the like of the sheet region 302 on the basis of the setting values set in the “paper type” setting 306 and the “paper size” setting 307.

A “clear coat” setting 309 is a setting item that designates a clear ink application mode, which is a printing mode in which printing is performed using transparent, i.e., clear, ink, and the user can switch the method for applying clear ink using this setting item. In the present embodiment, a plurality of types of clear ink application modes are provided, and the method for applying clear ink differs depending on the mode. The clear ink application modes will be described later. The “borderless printing” setting 310 is a setting item for specifying whether to enable or disable borderless printing. Borderless printing is disabled in FIG. 3A. Accordingly, the user can change the size of the image 303, change the position of the image 303, and the like on the sheet region 302. The margin region 304 can be set by the user changing the size, the position, and the like of the image 303.

A “print” button 311 is a button for passing, to the printer driver 203 designated in the “printer” setting 305, the print setting information designated through the “paper type” setting 306 to the “borderless printing” setting 310, as well as layout information (rendering information) for the image 303 with respect to the sheet region 302, resulting from editing tasks performed by the user. FIG. 3A illustrates an example of settings for printing a landscape-oriented image at A4 size on glossy paper in a clear ink application mode corresponding to “image only”. Note that the print setting information may include information set through settings other than the “paper type” setting 306 to the “borderless printing” setting 310.

FIG. 3B illustrates the screen when borderless printing is enabled due to a check box in a “borderless printing” setting 310 being checked. In other words, in FIG. 3B, the user cannot use a pointing device or the like, for example, to directly manipulate the size, position, and the like of the image 303. In FIG. 3B, the size of the image 303 is controlled to be slightly larger than the sheet region 302. In other words, the margin region 304 illustrated in FIG. 3A is not present in FIG. 3B.

The clear ink application mode set using the “clear coat” setting 309 will be described next. In the present embodiment, the user can selectively specify the method for applying clear ink to the sheet, and these methods will be collectively called “clear ink application modes”.

The “clear coat” setting 309 in FIGS. 3A and 3B is an element for setting the method for applying clear ink to the sheet. The “clear coat” setting 309 uses a pull-down menu to display a list of clear ink application modes provided by the printer driver 203. When the user selects a desired clear ink application mode from the pull-down menu, the selected clear ink application mode is set. In the present embodiment, the clear ink application modes include four modes, which are displayed as “all”, “image only”, “automatic”, and “none” in the pull-down menu. By selecting a desired mode from the four modes, the user can specify the method for applying clear ink to the sheet. Note that the clear ink application mode is set to a mode corresponding to “automatic” by default. Each of the clear ink application modes will be described hereinafter.

In the present embodiment, the mode in which “all” is selected and set is called a “full-surface application mode”. The full-surface application mode is a mode in which clear ink is applied to the entire printable region of the sheet. The “printable region” is a region obtained as a region within a predetermined margin on the basis of the specified sheet size, and is a region that can be determined from the sheet size. The “printable region” is a margin provided for the printing operations performed by the printing apparatus 102, and is different from the “margin region” (“border region”) described above. In the present embodiment, “margin region” or “border region” is assumed to refer to a white region, different from the image region, which can be set when borderless printing is disabled. If borderless printing is disabled, or in other words, when a border is set, the border region may be present in the printable region. As such, when borderless printing is disabled and the full-surface application mode is being used, clear ink is applied to the entire printable region, which means that clear ink is applied not only to the image region, but also to the margin region.

In the present embodiment, the mode in which “automatic” is selected and set is called an “automatic application mode”. The automatic application mode is a mode in which clear ink is applied to regions other than white regions. Note that “white region” refers to a region in which no color ink is applied, i.e., a region where the sheet is white, for example. In other words, unlike the full-surface application mode, clear ink is not applied to the margin region 304. Furthermore, if a white region is included in the image region, clear ink is not applied to the white region within the image region. If borderless printing is enabled by the “borderless printing” setting 310, the image region is controlled to be slightly larger than the sheet region 302, and the printable region is therefore included. Accordingly, when borderless printing is enabled, the display in the “clear coat” setting 309 may be controlled such that the automatic application mode cannot be selected.

Printing media such as paper include media in which the effects of applying clear ink are prominent, and media in which such effects are not prominent. For example, transparent ink provides little effect when applied to plain paper, matte-coated paper, and the like. On the other hand, effects such as uniform glossiness and an expanded color gamut can be achieved by applying clear ink to glossy paper and the like. As such, for example, the types of paper to which the automatic application mode is to be applied may be set in advance, and whether the automatic application mode is to be applied may be switched on the basis of information on the type of the paper obtained from the print setting information. In other words, the display may be controlled such that the automatic application mode can or cannot be selected, on the basis of the information on the type of the paper obtained from the print setting information.

In the present embodiment, the mode in which “none” is selected and set is called a “non-clear ink application mode”. When the non-clear ink application mode is set, printing is performed without using clear ink.

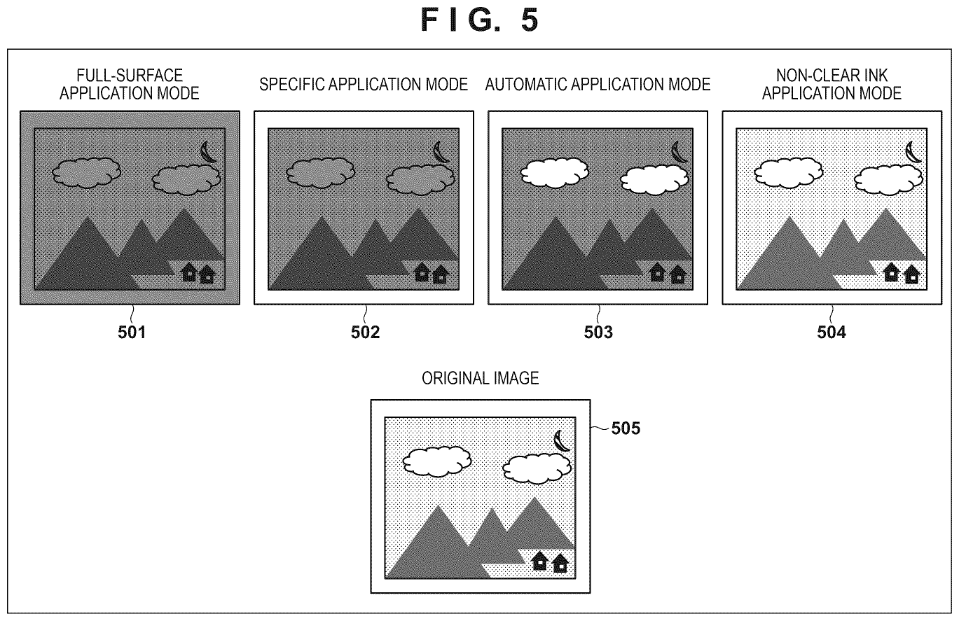

FIG. 4 is a diagram illustrating relationships between (i) the clear ink application modes and (ii) usage locations and usage amounts of clear ink. FIG. 5 is a diagram illustrating differences in the printing results provided by the clear ink application modes. In printing results 501 to 504 illustrated in FIG. 5, the parts where clear ink is applied are indicated by being darker than an image 505 which is formed on a sheet on the basis of the image data without using clear ink (i.e., an original image). Note that the margin region is set in the printable region in the printing results 501 to 504.

When the full-surface application mode is set, the printing apparatus 102 applies clear ink to the entire printable region, as indicated in FIG. 4 and in the printing result 501. Applying clear ink to the entire printable region makes it possible to improve the glossiness of the entire printable region, including the margin region. However, doing so may increase the amount of clear ink used, and the texture of the paper may be diminished due to the application of clear ink.

When the automatic application mode is set, the printing apparatus 102 applies clear ink only to locations where ink has been applied, as indicated in FIG. 4 and in the printing result 503. In the automatic application mode, clear ink is applied to regions other than regions corresponding to a combination of the margin region and the white regions within the image region. For example, clear ink is not applied to white regions within the image region, such as the images of clouds, in the printing result 503. It is possible, therefore, that the user will feel a sense of unevenness in the glossiness near the white regions within the image region.

When the non-clear ink application mode is set, the printing apparatus 102 prints without using clear ink, as indicated in FIG. 4 and in the printing result 504. For example, the user can suppress the use of clear ink by selecting the non-clear ink application mode in situations such as where they wish to laminate the medium after printing. The “clear coat” setting 309 can therefore also be said to be a control for switching the location where clear ink is used, the amount of clear ink used, and the like.

In the present embodiment, the clear ink application modes also include a mode in which “image only” is selected using the “clear coat” setting 309. In the present embodiment, the mode in which “image only” is selected and set is called a “specific application mode”. When the specific application mode is set, the printing apparatus 102 applies clear ink only to image regions excluding the margin region, as indicated in the printing result 502. In the present embodiment, control is performed to separate white regions within the image region from the margin region, and this will be described later. Unlike the automatic application mode, in the specific application mode, clear ink is also applied to white regions within the image region. The glossiness in the image region can therefore be made uniform. If borderless printing is enabled by the “borderless printing” setting 310, the image region is controlled to be slightly larger than the sheet region 302, and the printable region is therefore included. Accordingly, when borderless printing is enabled, the display in the “clear coat” setting 309 may be controlled such that the specific application mode cannot be selected.

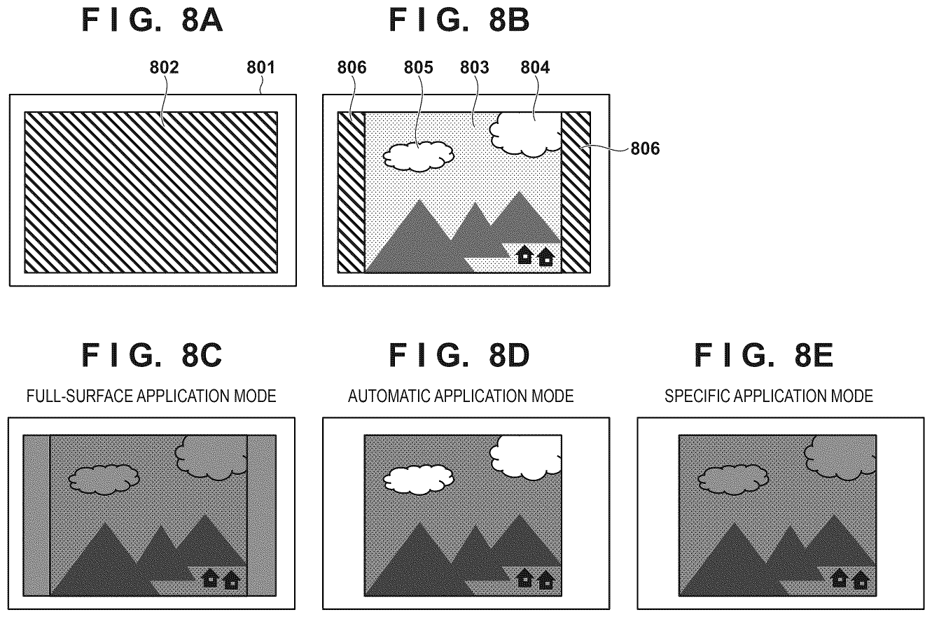

An example of printing in each of the clear ink application modes when borderless printing is disabled, i.e., when a border region is set, will be described with reference to FIGS. 8A to 8E. Unlike FIG. 5, the printable region is also illustrated in FIGS. 8A to 8E. FIG. 8A is a diagram illustrating a printable region 802 on a sheet region 801. The sheet region 801 corresponds to the sheet region 302 illustrated in FIG. 3A. Note that the regions corresponding to the printable regions 802 are not illustrated in FIGS. 3A and 3B. FIG. 8B illustrates an image 803 laid out in the printable region 802, in a state where a margin region 806 is set. Note that a cloud 804 and a cloud 805 are present in the image 803. Here, the cloud 804 is in contact with the edge of the image region of the image 803.

FIG. 8C illustrates a printing result when the full-surface application mode has been selected using the “clear coat” setting 309. Locations indicated darker than the image 803 indicate that the clear ink has been applied thereto. A region of the cloud 804 is in contact with the margin region 806 and equal amounts of clear ink are applied to both regions. As a result, there is no difference in the glossiness of the regions, and the part corresponding to the boundary therebetween becomes unclear. FIG. 8D illustrates a printing result when the automatic application mode has been set using the “clear coat” setting 309. The region of the cloud 804 is in contact with the margin region 806, and clear ink is applied to neither of the regions. As a result, the part corresponding to the boundary therebetween becomes unclear. FIG. 8E illustrates a printing result when the specific application mode has been set using the “clear coat” setting 309. Although the region of the cloud 804 is in contact with the margin region 806, clear ink is applied to the region of the cloud 804, but is not applied to the margin region 806. This produces a difference in glossiness, and the part corresponding to the boundary between the region of the cloud 804 and the margin region 806 is clear.

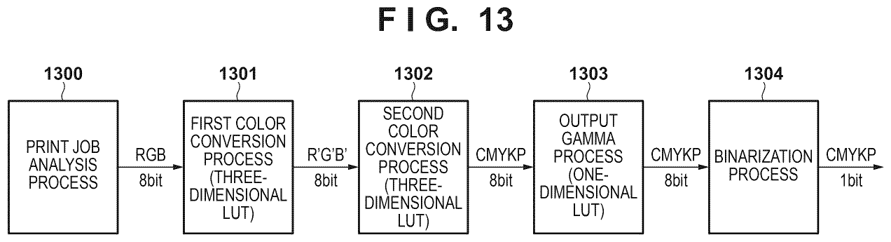

The foregoing has described the differences between the clear ink application modes, and the printing results obtained from those modes, according to the present embodiment. Image processing for generating (outputting) print data on the basis of a print job received by the printing apparatus 102 from the information processing apparatus 101 will be described next with reference to FIG. 13. As described above, a print job includes image data converted into a data format that can be interpreted by the printing apparatus 102, print setting information pertaining to print settings, and print commands. The print setting information includes, for example, information set through the “paper type” setting 306 to the “borderless printing” setting 310 illustrated in FIG. 3. The image data received by the printing apparatus 102 and converted into a data format that can be interpreted by the printing apparatus 102 will be called simply “image data” hereinafter.

In the present embodiment, as one example, in the image processing illustrated in FIG. 13, the printing apparatus 102 inputs image data having 8 bits for each of red (R), green (G), and blue (B) (i.e., 256 tones). Through the image processing illustrated in FIG. 13, the input image data is output as print data having 1 bit for each of cyan (C), magenta (M), yellow (Y), black (K), and clear ink (P). Although the present embodiment describes an example in which C, M, Y, and K color inks are used, the inks are not limited thereto, and other color inks may be used. For example, intermediate color inks such as light magenta, light cyan, or the like may be used, or monotone inks such as light gray, gray, dark gray, photo black, matte black, or the like may be used. For example, the printing apparatus 102 may be configured to be capable of using 12 colors by adding the inks mentioned above to C, M, Y, and K.

Furthermore, the numbers of bits in the image data input to the image processing and in the print data output from the image processing are not limited to those mentioned above. For example, the image data may have 16 bits for each of R, G, and B, and the print data may be multivalue data having 2 bits for each of C, M, Y, K, and P (i.e., 4 tones).

The image processing executed by the printing apparatus 102 includes a print job analysis process 1300, a first color conversion process 1301, a second color conversion process 1302, an output gamma process 1303, and a binarization process 1304, as illustrated in FIG. 13. Although each process is, for example, a unit of processing executed by the CPU 121 of the printing apparatus 102, each process will be described as the entity executing the corresponding processing.

First, the print job analysis process 1300 analyzes the print job, and obtains the image data and the print settings information. Note that the items obtained from the print job are not limited thereto, and print commands may also be obtained, for example. Here, the image data may be rasterized such that the image data can be processed on a pixel-by-pixel basis in later stages. 8-bit RGB image data is input to the first color conversion process 1301.

The first color conversion process 1301 uses a three-dimensional lookup table (LUT) to convert the 8-bit RGB image data into 8-bit data for each of R′, G′, and B′ (called “R′G′B′ data” here). In other words, the processing for converting from the image data to the R′G′B′ data is processing for correcting a difference between the color space with which the input image data is expressed and the color space that can be reproduced by the printing apparatus 102. That is, the processing converts the color space with which the input image data is expressed into a device-independent color space, and converts a device-independent color space into a color space dependent on the printing apparatus 102. Here, the “device-independent color space” is the XYZ color space, for example.

Although a three-dimensional LUT is used in the first color conversion process 1301, the three-dimensional LUT does not need to have grid points for all input combinations. For example, data may be prepared only for points, on the three-dimensional color space, that are at predetermined intervals, and the points other than those at the predetermined intervals may be interpolated.

The R′G′B′ data output from the first color conversion process 1301 is input to the second color conversion process 1302. The second color conversion process 1302 uses a three-dimensional LUT for conversion into 8-bit data for each of C, M, Y, K, and P data (called “CMYKP data” here). In other words, the processing performed in the second color conversion process 1302 is processing for converting RGB data of the input system, expressed by luminance signals, into CMYK data of the output system, expressed by density signals. Note that processing such as masking, undercolor removal, black generation, and the like may be performed in the second color conversion process 1302.

Although a three-dimensional LUT is used in the second color conversion process 1302, the three-dimensional LUT does not need to have grid points for all input combinations. For example, data may be prepared only for points, on the three-dimensional color space, that are at predetermined intervals, and the points other than those at the predetermined intervals may be interpolated.

The CMYKP data output from the second color conversion process 1302 is input to the output gamma process 1303. The output gamma process 1303 executes gamma correction on the input CMYKP data using a one-dimensional LUT. Generally speaking, the number of dots formed by ejecting ink per unit of area on a sheet is not in a linear relationship with output characteristics such as a reflection density obtained by measuring the dots. Gamma correction makes it possible to establish a linear relationship between the input tone levels of the 8-bit CMYKP colors and the density levels of the image to be printed.

The gamma-corrected CMYKP data output from the output gamma process 1303 is input to the binarization process 1304. The binarization process 1304 quantizes the gamma-corrected CMYKP data. Print data having 1 bit for each of the C, M, Y, K, and P colors is output as a result of the quantization. Then, ink is ejected onto a sheet on the basis of the print data, and an image is formed on the sheet.

Changes in output values of the clear ink relative to tone values, in the full-surface application mode and the automatic application mode, will be described next. Note that “output value” corresponds to the amount of ink ejected onto the sheet.

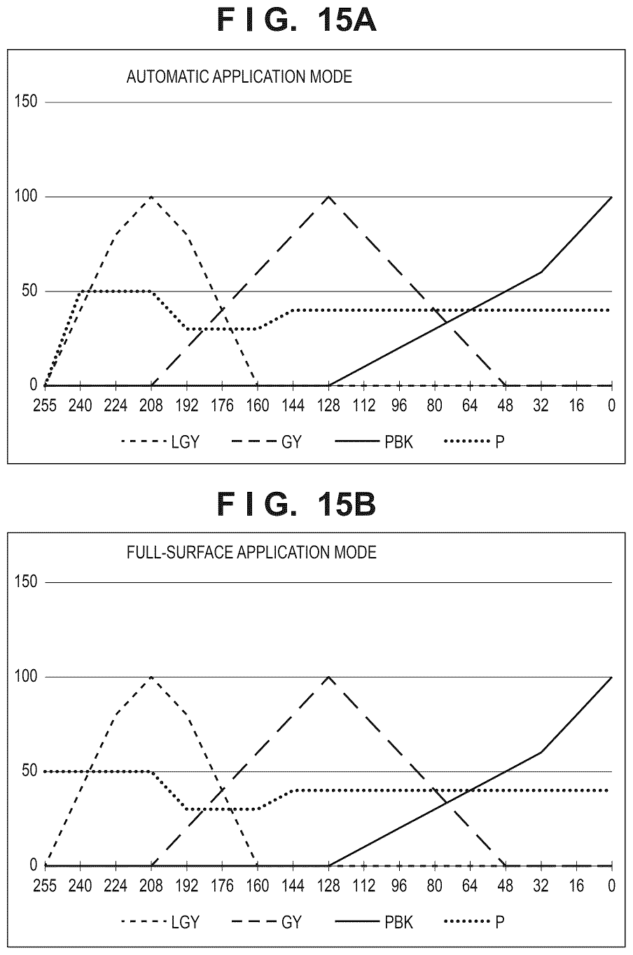

FIG. 15 is a diagram illustrating changes in the output values of the clear ink relative to the tone values, determined in the second color conversion process 1302. In the present embodiment, the output values are held in LUT format, and are therefore denoted in a discrete manner. FIG. 15A illustrates changes in the output values of the clear ink (P) relative to the tone values in the automatic application mode. FIG. 15B illustrates changes in the output values of the clear ink (P) relative to the tone values in the full-surface application mode. As one example, FIGS. 15A and 15B illustrate, in an LUT in which 12 colors of monotone-type ink have been added to CMYK, a gray line from white, i.e., R=G=B=255 (white dots, on the LUT) to black, i.e., R=G=B=0 (black dots, on the LUT). In addition to the clear ink, light gray (LGY), gray (GY), and photo black (PBK) monotone inks are also indicated in FIG. 15A. Generally speaking, when monotone inks such as light gray, gray, photo black, and matte black are added to CMYK, a smoother tonality from white to black can be expressed in monotone parts. In FIGS. 15A and 15B, the vertical axis represents the output value per unit of area for each ink, and 100 is assumed to be the maximum value.

According to FIGS. 15A and 15B, only light gray (LGY) ink is used for printing from white, where R=G=B=255, to R=G=B=208. Gray (GY) ink is added from R=G=B=208, and thus the output value of light gray ink reaches a maximum around R=G=B=208 and then begins to decrease. Photo black (PBK) ink is added from R=G=B=128, and thus the output value of gray ink decreases after reaching a maximum. Only photo black ink is used at the end, at the last R=G=B=0. Note that in the gray line, other color inks are also generally combined to adjust the color, but this is omitted from the present example.

As described above, in the full-surface application mode, clear ink is applied to the entire printable region of the sheet. In the present embodiment, as illustrated in FIG. 15B, control is performed to output more clear ink in a density range where mainly light gray ink is output as a single color, from R=G=B=255 to the vicinity of R=G=B=208. The reason for this will be described below.

Generally speaking, pigment-based ink is different from dye-based ink in that when applied to glossy paper, pigment particles remain on the surface of the glossy paper. Accordingly, the gloss of the pigment particles themselves is prominent in parts where more pigment-based ink is used, and more light is reflected only by those parts.

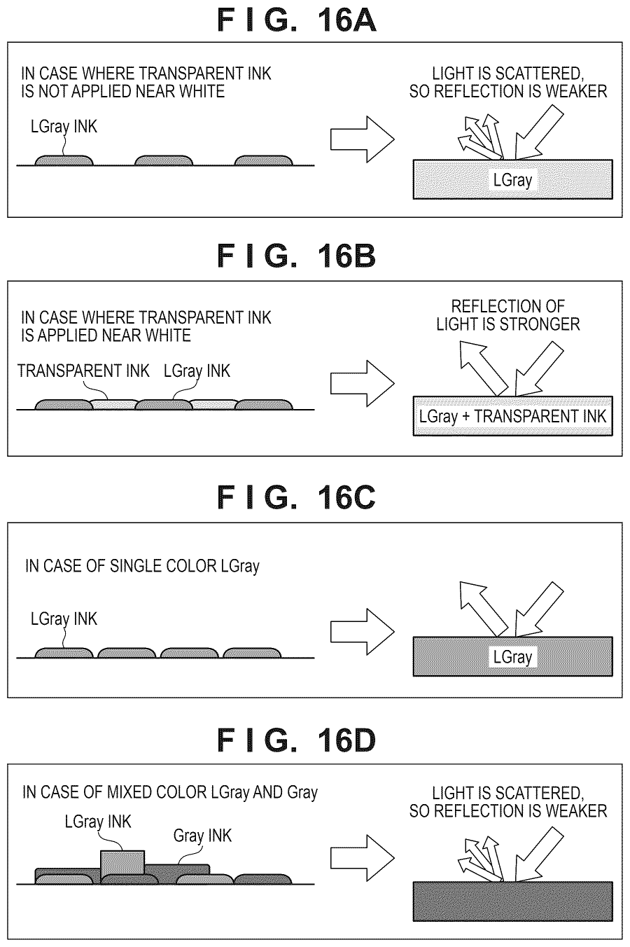

This light reflection will be described with reference to FIGS. 16A to 16D. The white arrows in FIGS. 16A to 16D represent light. As illustrated in FIGS. 15A and 15B, near white, the output value of light gray ink is low. In this case, in a dot cross-sectional image per unit of area, the parts where light gray ink is applied and the parts where the surface of the sheet is exposed are intermixed, as illustrated in FIG. 16A.

Typically, unless the printing medium is a film or the like, the light reflected by the glossy paper itself is weaker than the light reflected by the parts covered with the pigment-based ink. As such, the more parts of the surface of the sheet are exposed, the weaker the reflection of light becomes. Additionally, in this case, the surface of the sheet is uneven between the parts where light gray ink is applied and the parts where light gray ink is not applied. In this case, as indicated by the illustration of light reflection in FIG. 16A, the light is scattered by unevenness in the image surface, and the reflection of the light weakens as a result. Using more clear ink to fill the gaps produced by the unevenness arising near white reduces the unevenness in the surface of the sheet, which suppresses the scattering of light, as illustrated in FIG. 16B. In other words, the reflection of light is strengthened, which makes it possible to achieve glossiness which is uniform with the parts where other colors of ink are applied.

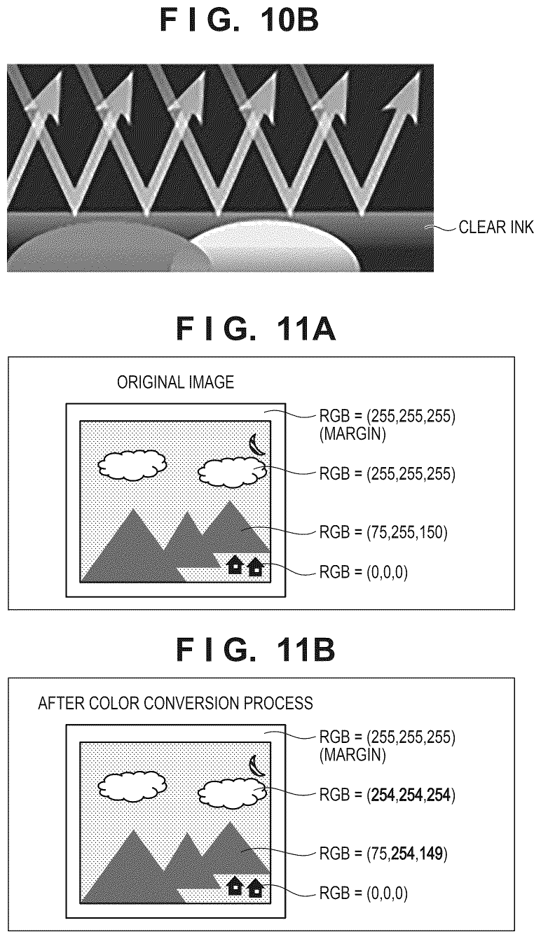

FIGS. 10A and 10B are diagrams illustrating an effect of clear ink. FIG. 10A illustrates a state where light is reflected in various directions due to differences in the height of the ink produced by colored pigment-based ink. On the other hand, FIG. 10B illustrates how the reflected light is made uniform by applying clear ink. In this manner, applying clear ink can reduce unevenness in the glossiness.

Near R=G=B=208, i.e., where the output value of light gray ink reaches a maximum, if, as illustrated in FIG. 16C, the sheet is covered almost entirely with light gray ink (almost entirely by a single color), unevenness on the surface of the sheet decreases, which tends to strengthen the reflection of light by the pigment particles themselves. Accordingly, more clear ink is required to cover the pigment particles and provide uniform glossiness. On the other hand, as illustrated in FIG. 16D, in parts where light gray ink and gray ink are used together, the light gray ink and the gray ink are applied randomly during printing over a plurality of passes, which produces unevenness on the surface of the sheet. This causes light to scatter, and the reflection of light by the pigment particles themselves becomes relatively weaker than when printing with a single color. In other words, a reduced amount of clear ink can be applied in density ranges higher than density ranges where a plurality of colors of ink are used together. The following can be given as a summary of the foregoing.

With white, it is necessary to increase the amount of clear ink that is applied in order to cover the surface of the sheet with clear ink and increase the reflection of light. Near white, it is necessary to increase the amount of clear ink that is applied in order to suppress the reflection of light in parts where the sheet is almost covered only with light gray ink (almost entirely by a single color). In parts where a plurality of colors of ink, such as light gray ink and gray ink, are applied, unevenness in the surface of the image arises, which makes the reflection of light relatively weaker, despite the pigment particles themselves being glossy. The amount of clear ink that is applied can therefore be reduced more than in areas that are white or near white.

As illustrated in FIG. 15A, when clear ink is applied in the automatic application mode, processing is performed such that clear ink is not applied for white. This is because some applications and OSs may not have a function for accurately outputting information of objects for specifying image regions, and in such a case, clear ink cannot be applied only to a certain image region by specifying that image region. In such a case, rather than specifying the image region, a method is used in which clear ink is applied only to parts where color ink has been applied, and clear ink is not applied to white regions.

If the output value for clear ink at white is set to zero, the clear ink gradually increases near white (e.g., tone values from 254 to 240) due to interpolation, as illustrated in FIG. 15A. Note that the control of the output values of clear ink at tone values from 240 to 0 in the automatic application mode is the same as in the full-surface application mode. In the automatic application mode, the glossiness at white and near white (e.g., tone values from 255 to 240) changes smoothly, but compared to the full-surface application mode, the glossiness becomes less uniform at white and near white (e.g., tone values from 255 to 240).

FIG. 12 is a diagram illustrating the relationship between the input values and the output values of the second color conversion process 1302. In FIG. 12, “%” for the output value represents the output value (ejection amount) per unit of area, where the maximum value is 100%. Note that only the output values for clear ink are shown in FIG. 12.

In the automatic application mode, the output values are 0% for an input value of 255, 3% for an input value of 254, 25% for an input value of 248, and 50% for and input value of 240. The output values are calculated through interpolation, which results in a lower amount for input values of 254 and 248. In the full-surface application mode, the output values are 50% for an input value of 255, 50% for an input value of 254, 50% for an input value of 248, and 50% for an input value of 240. As such, a sufficient amount of clear ink is applied for the input values of 254 and 248. In the specific application mode, the output values are 0% for an input value of 255, 50% for an input value of 254, 50% for an input value of 248, and 50% for an input value of 240, as a result of the image processing performed when the specific application mode is set (described later). As such, a sufficient amount of clear ink is applied for the input values of 254 and 248. Note that no ink other than clear ink is used for the input value of 255, in any of the modes.

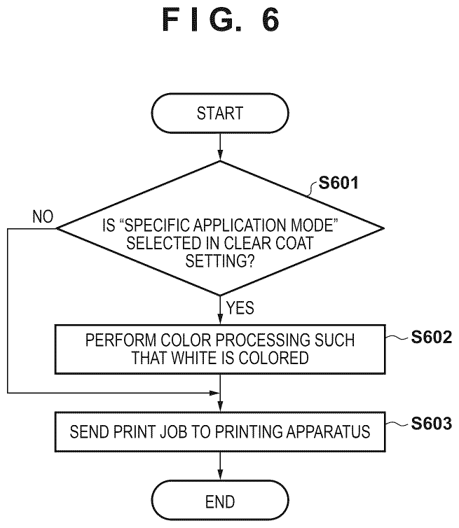

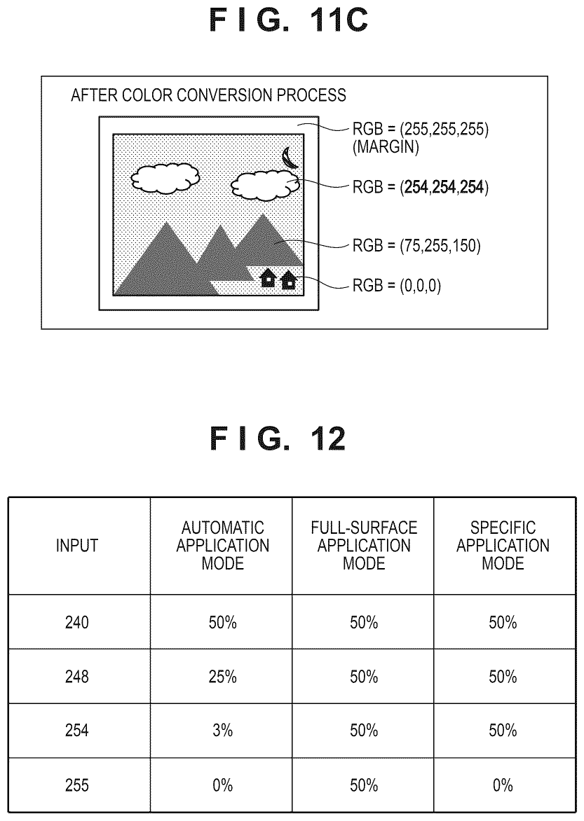

Processing performed by the application 202 will be described next. FIG. 6 is a flowchart illustrating processing performed by the application 202 when the clear ink application mode has been selected by the user in the “clear coat” setting 309. The processing in FIG. 6 is implemented, for example, by the CPU 111 of the information processing apparatus 101 reading out a program stored in the ROM 112 into the RAM 113 and executing that program. The processing illustrated in FIG. 6 is started when the print button 311 is pressed, for example. The following descriptions will assume that the application 202 is the main entity performing the processing. However, the processing may be implemented by having another program executed by the CPU 111 for some of the processing illustrated in FIG. 6. Furthermore, it is assumed that prior to the start of the processing illustrated in FIG. 6, image data has been generated as a result of the user operating the application 202. FIG. 11A illustrates an example of an image based on the generated image data. FIG. 11A illustrates, as an example, an RGB value for the margin region and the regions corresponding to “cloud” images (255, 255, 255), an RGB value for regions corresponding to a “mountain” image (75, 255, 150), and an RGB value for regions corresponding to a “house” image (0, 0, 0).

In step S601, the application 202 determines whether the specific application mode is selected by the user in the “clear coat” setting 309. The sequence moves to step S602 if the specific application mode is determined to be selected, and to step S603 if not. A case where the specific application mode is not selected is, for example, a case where another mode is selected, in which case control is performed such that the processing of step S602 is not executed. In other words, the information is sent to the printing apparatus 102 with the RGB values illustrated in FIG. 11A kept as-is.

In step S602, the application 202 performs color conversion processing on the image data such that white regions within the image region are slightly colored. For example, if the image data is 8-bit RGB data, RGB=(255, 255, 255) is the RGB value corresponding to white. In other words, when that image data is sent to the printing apparatus 102, the regions of pixels assigned an RGB value of (255, 255, 255) within the image region are printed as white. In the present embodiment, the color conversion processing is performed such that the RGB values of pixels to which the RGB value corresponding to white has been assigned are converted to an RGB value corresponding to a color aside from white. Specifically, for example, the “RGB value corresponding to a color aside from white” is RGB=(254, 254, 254). In the color conversion processing performed in step S602, the RGB values may, for example, be normalized such that tones in the RGB color space are shifted from a range of 0 to 255 to a range of 0 to 254. For example, if the RGB values in the image data corresponding to the image illustrated in FIG. 11A are normalized such that the tones of the RGB color space are in the range of 0 to 254, the result of the processing will be as illustrated in FIG. 11B. In this case, the RGB values of intermediate colors aside from white are also slightly different in the result. In the example illustrated in FIG. 11B, the color RGB=(75, 255, 150) has changed to RGB=(75, 254, 149). Note that in step S602, the color conversion processing is not executed for the margin region. Accordingly, the RGB value corresponding to white (255, 255, 255) is kept as-is for the RGB value in the margin region.

As another color conversion processing method, pixels to which an RGB value corresponding to white is assigned may be detected within the image region, and those pixels may be converted to an RGB value of (254, 254, 254). For example, if only the locations assigned the RGB value corresponding to white are subjected to the color conversion in the image data expressing the image illustrated in FIG. 11A, the result of the processing will be as illustrated in FIG. 11C. In this case, the RGB values of the pixels assigned an RGB value corresponding to a color aside from white are unchanged in the result. Note that even in the case of FIG. 11C, the color conversion processing is not performed for the margin region, and thus the RGB value corresponding to white, i.e., (255, 255, 255), is kept as-is for the RGB value of the margin region. The pixels subject to such color conversion processing may be detected, for example, by an operation for specifying a color, performed by the user on the image displayed on the screen.

In this manner, in the present embodiment, the margin region, and white regions within the image region, are separated in the image data. Although the present embodiment describes an example in which the RGB value of (255, 255, 255) is converted to (254, 254, 254) as the color conversion processing, the configuration is not limited thereto, and for example, at least one of the R, G, and B color components may be changed to 254. The conversion is also not limited to the example in which the tone values are converted from 255 to 254, and any tone value near white, which cannot easily be identified by the user, may be used.

The processing of step S602 results in the white regions within the image region being colored slightly, and only the margin region having an RGB value of (255, 255, 255). Although the color conversion processing is performed on the image data in step S602, the result of the color conversion processing is not applied to the image 303 displayed in the preview region 301. In other words, the image 303 displayed in the preview region 301 is an image displayed on the basis of the image data for which the pixel values have not been converted. This is because the processing of step S602 is not performed on the basis of the user explicitly instructing coloring, and it is difficult for the user to confirm the color difference in the preview image displayed. However, the result of the color conversion processing may be applied to the image 303 displayed in the preview region 301. In other words, the image 303 displayed in the preview region 301 may be an image displayed on the basis of the image data subjected to the color conversion processing, i.e., for which the pixel values have been converted. A configuration may also be employed in which the image 303 displayed in the preview region 301 can be switched between the image data for which the pixel values have not been converted and the image data for which the pixel values have been converted.

In step S603, the application 202 sends the print job containing the image data, the print setting information including the selection in the “clear coat” setting 309, and the print command to the printing apparatus 102, after which the processing of FIG. 6 ends.

As described with respect to the automatic application mode and the specific application mode, when borderless printing is enabled, the display in the “clear coat” setting 309 may be controlled such that the automatic application mode and the specific application mode cannot be selected. However, the automatic application mode and the specific application mode may be made selectable in the “clear coat” setting 309 when borderless printing is enabled. For example, when borderless printing is enabled and the specific application mode is selected, in step S601, the control may be performed under the assumption that the full-surface application mode has been selected, i.e., a determination of “No” is made in step S601 and the sequence moves to step S603. In this case, the color conversion processing of step S602, i.e., the pixel value conversion, is not performed. Even in such a case, clear ink is applied to the entire printable region, and thus the same effect can be achieved as when the color conversion processing is performed in the specific application mode.

Processing performed in the printing apparatus 102 will be described next. As described above, the printing apparatus 102 generates print data by performing the image processing illustrated in FIG. 13 on the image data included in the print job received from the information processing apparatus 101. The extent to which clear ink is applied in the image processing is controlled by the LUT used in the second color conversion process 1302.

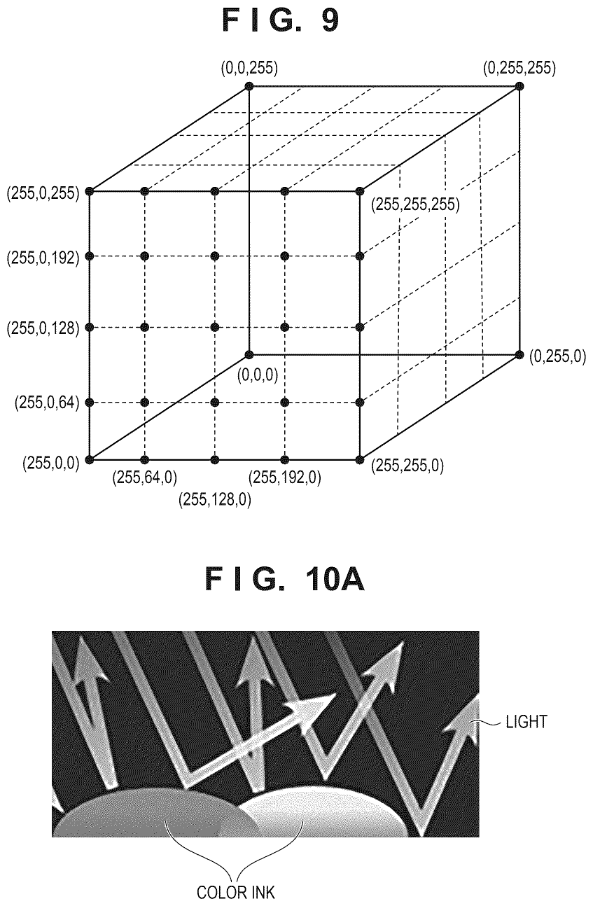

FIG. 9 is a diagram illustrating the LUT used in the second color conversion process 1302. As illustrated in FIG. 9, output values are defined discretely for each grid point in the LUT, and the output values between grid points are calculated through interpolation. The LUT illustrated in FIG. 9 is assumed to have grid points such as (255, 255, 255), (240, 240, 240), (224, 224, 224), and so on down to (0, 0, 0). In the present embodiment, ink separation is performed in the second color conversion process 1302 using the LUT in which the output values are defined discretely for each grid point, as illustrated in FIG. 9.

In the present embodiment, the printing apparatus 102 has two LUTs, namely an LUT for the full-surface application mode, and an LUT for the automatic application mode. In other words, the ink separation is performed using an LUT unique to the full-surface application mode and the automatic application mode, respectively. Specifically, an LUT with which ink separation is performed as indicated in FIG. 15B is used in the full-surface application mode, and an LUT in which ink separation is performed as indicated in FIG. 15A is used in the automatic application mode, for example. On the other hand, unique LUTs are not provided for the non-clear ink application mode and the specific application mode, and the ink separation is performed through control using the LUT for another clear ink application mode.

In the print job analysis process 1300, the printing apparatus 102 obtains the image data, print setting information, and print commands from the print job received from the information processing apparatus 101. In addition, the printing apparatus 102 analyzes the print setting information, and on the basis of the information in the “clear coat” setting 309, obtains information about the clear ink application mode which is set. Specifically, for example, the printing apparatus 102 obtains information as to which of the automatic application mode, the full-surface application mode, the specific application mode, and the non-clear ink application mode is set.

The image processing performed when the automatic application mode is set will be described here. When the automatic application mode is set, after the print job analysis process 1300 is performed, the printing apparatus 102 converts the image data into R′G′B′ data in the first color conversion process 1301. Next, in the second color conversion process 1302, the printing apparatus 102 performs ink separation using the LUT for the automatic application mode. The LUT for the automatic application mode provides that clear ink is not applied for white, i.e., for an RGB value of (255, 255, 255). Accordingly, control is performed such that clear ink is not applied to the margin region and white regions within the image region. After that, the printing apparatus 102 performs the output gamma process 1303 and the binarization process 1304, and generates the print data.

The image processing performed when the full-surface application mode is set will be described next. When the full-surface application mode is set, after the print job analysis process 1300 is performed, the printing apparatus 102 converts the image data into R′G′B′ data in the first color conversion process 1301. Next, in the second color conversion process 1302, the printing apparatus 102 performs ink separation using the LUT for the full-surface application mode. The LUT for the full-surface application mode provides that clear ink is applied for white, i.e., for an RGB value of (255, 255, 255). Accordingly, control is performed such that clear ink is applied to the margin region and white regions within the image region. After that, the printing apparatus 102 performs the output gamma process 1303 and the binarization process 1304, and generates the print data.

The image processing performed when the non-clear ink application mode is set will be described next. When the non-clear ink application mode is set, after the print job analysis process 1300 is performed, the printing apparatus 102 converts the image data into R′G′B′ data in the first color conversion process 1301. Next, in the second color conversion process 1302, the printing apparatus 102 performs ink separation using the LUT for the automatic application mode. Because the LUT for the automatic application mode is used, clear ink is not applied to the margin region and white regions within the image region, but clear ink is applied to regions other than white regions within the image region. In the output gamma process 1303, the printing apparatus 102 performs processing to set, to zero, the output values of only clear ink included in the processing result of the second color conversion process 1302. After that, the printing apparatus 102 performs the binarization process 1304, and generates the print data. In this manner, in the non-clear ink application mode, clear ink is not applied to the entire printable region. Although the foregoing describes performing control for setting the output values of clear ink to zero using the LUT for the automatic application mode in the non-clear ink application mode, the LUT for the non-clear ink application mode may be used instead. Specifically, for example, an LUT in which the output values of clear ink are defined as zero may be used as the LUT for the non-clear ink application mode.

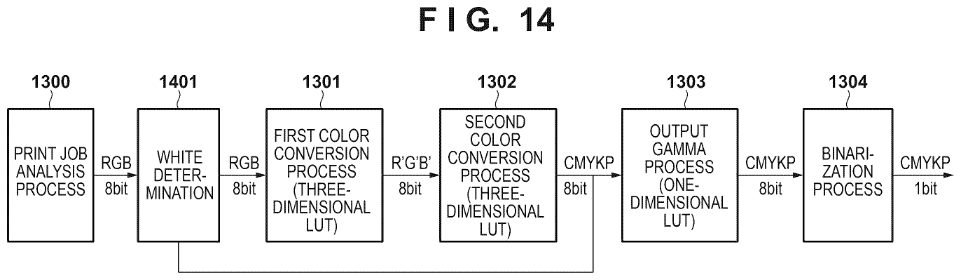

The image processing performed when the specific application mode is set will be described with reference to FIG. 14. When the specific application mode is set, the printing apparatus 102 performs a white determination process 1401 after the print job analysis process 1300. Note that the print job analysis process 1300 performs rasterization on the printable region, i.e., not only on the image region, but also on the margin region. The printing apparatus 102 then performs the white determination process 1401 using the rasterized image data. On the basis of the image data, the printing apparatus 102 determines whether the RGB value of each pixel is (255, 255, 255). The printing apparatus 102 sets information indicating a white attribute to 1 for the regions of pixels having an RGB value of (255, 255, 255). On the other hand, information indicating a white attribute is set to 0 for the regions of the pixels for which the values are not (255, 255, 255). In other words, the white determination process 1401 is processing for specifying regions of white pixels.

Next, in the first color conversion process 1301, the printing apparatus 102 converts the image data into R′G′B′ data. Next, in the second color conversion process 1302, the printing apparatus 102 performs ink separation using the LUT for the full-surface application mode. The LUT for the full-surface application mode provides that clear ink is applied for white, i.e., for regions of pixels having an RGB value of (255, 255, 255). Accordingly, at this point in time, the processing is performed such that clear ink is applied to the margin region and white regions within the image region.

Next, the printing apparatus 102 performs the output gamma process 1303 using the result of the white determination process 1401. The printing apparatus 102 performs processing to set the output values of only clear ink to zero, for regions of pixels having a white attribute of 1. In doing so, control is performed such that clear ink is not applied for an RGB value of (255, 255, 255), which is white. On the other hand, the same output gamma process 1303 as that used in the automatic application mode and the full-surface application mode is executed for regions of pixels having a white attribute of 0. After that, the printing apparatus 102 performs the binarization process 1304, and generates the print data. Through this, control is performed such that clear ink is not applied to white, i.e., to regions of pixels having an RGB value of (255, 255, 255), and that the same amount of clear ink as in the full-surface application mode is applied to regions of pixels other than pixels having the RGB value of (255, 255, 255). When the specific application mode is set, the image region does not include regions of white, i.e., having an RGB value of (255, 255, 255), as a result of the color conversion processing performed in step S602 of FIG. 6. Accordingly, the image region can be specified by executing the white determination process 1401, and control can be performed such that clear ink is applied to that image region but is not applied to the margin region.

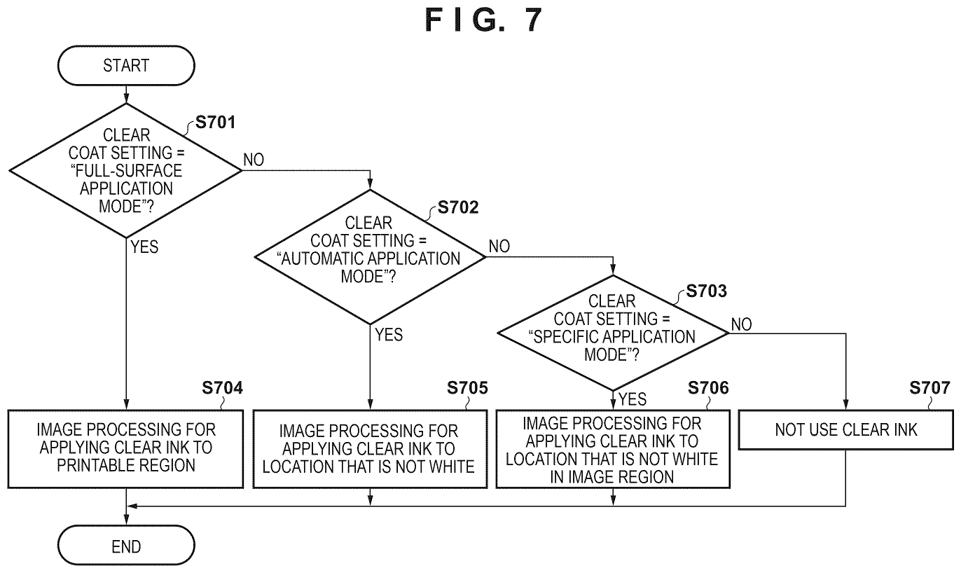

FIG. 7 is a flowchart illustrating processing performed by the printing apparatus 102 that has received the print job from the information processing apparatus 101. The processing in FIG. 7 is implemented, for example, by the CPU 121 reading out a program stored in the ROM 123 into the RAM 122 and executing that program.

In step S701, the CPU 121 refers to the print setting information included in the print job, and determines whether the full-surface application mode is set in the “clear coat” setting 309. The sequence moves to step S704 if the full-surface application mode is determined to be set, and to step S702 if the full-surface application mode is determined not to be set.

In step S704, the CPU 121 generates print data by performing the image processing described above for when the full-surface application mode is set, and forms an image on a sheet on the basis of the print data. The processing of FIG. 7 then ends.

In step S702, the CPU 121 refers to the print setting information included in the print job, and determines whether the automatic application mode is set in the “clear coat” setting 309. The sequence moves to step S705 if the automatic application mode is determined to be set, and to step S703 if the automatic application mode is determined not to be set.

In step S705, the CPU 121 generates print data by performing the image processing described above for when the automatic application mode is set, and forms an image on a sheet on the basis of the print data. The processing of FIG. 7 then ends.

In step S703, the CPU 121 refers to the print setting information included in the print job, and determines whether the specific application mode is set in the “clear coat” setting 309. The sequence moves to step S706 if the specific application mode is determined to be set, and to step S707 if the specific application mode is determined not to be set. For example, if the non-clear ink application mode is set in the “clear coat” setting 309, the sequence moves to step S707.

In step S706, the CPU 121 generates print data by performing the image processing described above for when the specific application mode is set, and forms an image on a sheet on the basis of the print data. The processing of FIG. 7 then ends.

In step S707, the CPU 121 generates print data by performing the image processing described above for when the non-clear ink application mode is set, and forms an image on a sheet on the basis of the print data. The processing of FIG. 7 then ends.

As described above, in the present embodiment, control of four types of clear ink application modes is implemented using only two types of LUTs, i.e., the LUT for the full-surface application mode and the LUT for the automatic application mode, rather than four types of LUTs used in the second color conversion process 1302. The LUT used in the second color conversion process 1302 is an LUT that separates the output ink colors from RGB, and is therefore the LUT having the largest data size in the image processing. Making it possible to reduce the number of LUTs can provide a major effect of reducing the data size.

As described above, according to the present embodiment, it is possible to apply clear ink to an image region even if the image region includes a white region, while avoiding applying the clear ink to a margin region. This makes it possible to suppress the amount of clear ink used while reducing unevenness in the glossiness of the image region, without diminishing the texture of the paper. The user can also switch the range of clear ink use (application) and the amount of clear ink used according to the use case by using the “clear coat” setting 309.

In the present embodiment, in step S602, white regions within the image region and the margin region are separated by adding color to the white regions within the image region. Normally, with a printing apparatus that handles data including margin regions, it is difficult to accurately identify the positions of the margin regions. However, according to the present embodiment, margin regions can be easily identified. Furthermore, special commands indicating the positions of the image region, the margin regions, or the like are not needed, which makes it possible to prevent an increase in the amount of information to be sent as the print job.

Although the present embodiment has described a case where the image data included in the print job received from the information processing apparatus 101 is data defined by the RGB color space, the configuration is not particularly limited thereto, and the data may be data defined by another color space, such as CMYK. Additionally, the data is not limited to 8-bit tones from 0 to 255, and may be other tones, such as 16-bit tones from 0 to 65535, or the like.

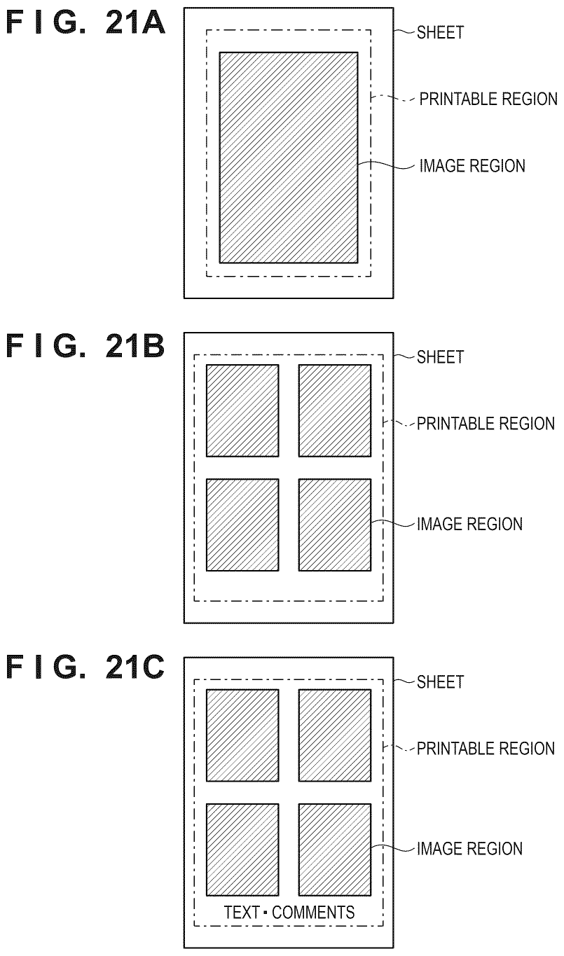

The configuration may be such that various layouts or the like can be specified in the application 202 with respect to the image expressed by the image data. For example, FIG. 21A illustrates a case where an image is arranged at a size smaller than the printable region, and corresponds to an example in which the margin region is set as described in the present embodiment. FIG. 21B, meanwhile, illustrates a case where a plurality of images are arranged in the printable region, for example. FIG. 21B illustrates an example in which four images for which a margin region has been set are arranged. FIG. 21C illustrates a case where a plurality of images are arranged in the printable region along with text, for example. FIG. 21C illustrates an example in which text and comments have been added to the content illustrated in FIG. 21B.

The present embodiment has described an example in which the output values of clear ink are first determined by performing color conversion on the printable region, after which the output values of clear ink are changed only for the image region, but the configuration is not limited thereto. For example, the image may first be divided into a printable region and a region, within the printable region, that is different from the image region, and different output values for the clear ink may be determined for each region. This makes it possible to apply clear ink only to the image region, and thus the same image effects can be achieved.

### Second Embodiment

A second embodiment will be described hereinafter, focusing on differences from the first embodiment. The first embodiment described performing ink separation using the LUT for the full-surface application mode in the second color conversion process 1302, and performing processing for setting the output values of the clear ink corresponding to the margin region to zero in the output gamma process 1303, to implement the specific application mode. Doing so achieves control such that clear ink is applied to the image region but is not applied to the margin region. Another configuration will be described in the present embodiment.

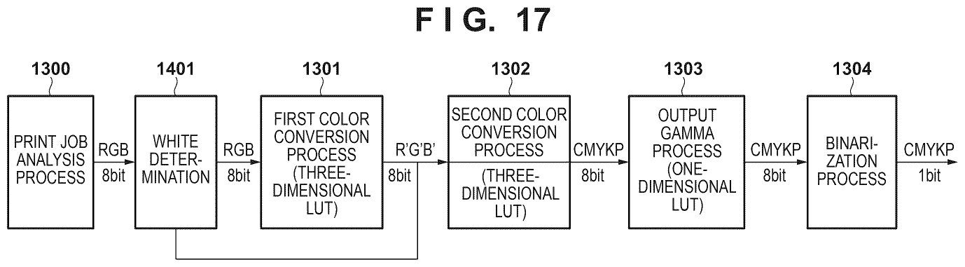

FIG. 17 is a diagram illustrating the flow of image processing in the printing apparatus 102. After the print job analysis process 1300, the printing apparatus 102 determines, in the white determination process 1401, whether the pixel value of each pixel in the image region is white. Specifically, whether the RGB value is (255, 255, 255) is determined, for example. Here, if the RGB value is (255, 255, 255), information indicating the white attribute is set to 1 for the pixel. However, if the RGB value is not (255, 255, 255), information indicating the white attribute is set to 0 for the pixel.

Next, in the first color conversion process 1301, the printing apparatus 102 converts the image data into R′G′B′ data. Next, in the second color conversion process 1302, the printing apparatus 102 performs ink separation using the LUT for the automatic application mode for pixels for which the information indicating the white attribute is set to 1, and performs ink separation using the LUT for the full-surface application mode for pixels corresponding to the information indicating the white attribute is set to 0. Doing so makes it possible to apply the same amount of clear ink as in the full-surface application mode to regions corresponding to pixels of colors aside from white, while avoiding applying clear ink to regions corresponding to pixels that are white, e.g., that have an RGB value of (255, 255, 255). The printing apparatus 102 performs the output gamma process 1303 and the binarization process 1304 after the first color conversion process 1301, and generates the print data.

As described above, in the present embodiment, control for four types of clear ink application modes can be implemented using only two types of LUTs, i.e., the LUT for the full-surface application mode and the LUT for the automatic application mode, in the second color conversion process 1302, without needing to prepare four types of LUTs corresponding to respective ones of the four modes. The LUT for the second color conversion process 1302 is an LUT that separates the output ink colors from RGB, and is therefore the LUT having the largest data size in the image processing. Making it possible to reduce the number of LUTs can provide a major effect of reducing the data size.

### Third Embodiment

A third embodiment will be described next, focusing on differences from the first and second embodiments. The first and second embodiments described a configuration in which control is performed such that the printing apparatus 102 applies clear ink by adding a slight color to white regions within the image region. The present embodiment will describe a configuration in which the user is notified that a slight color has been added to a white region.

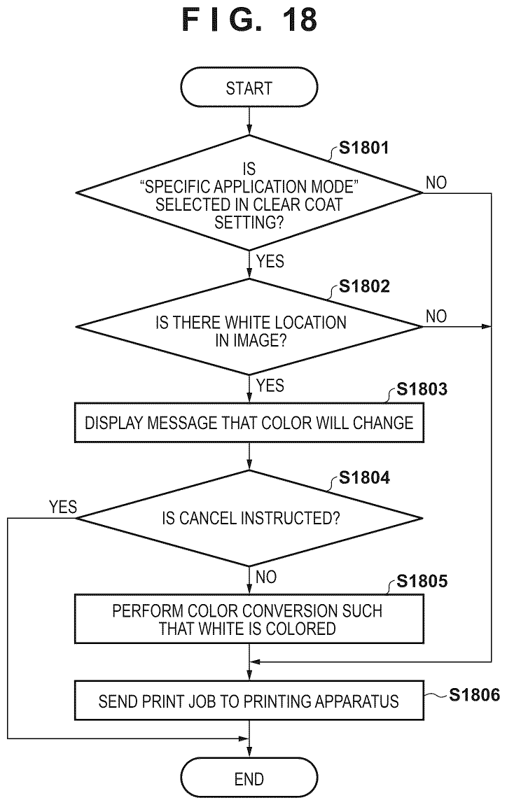

FIG. 18 is a flowchart illustrating processing performed by the application 202 when the specific application mode is selected by the user. The processing in FIG. 18 is implemented, for example, by the CPU 111 reading out a program stored in the ROM 112 into the RAM 113 and executing that program. The processing illustrated in FIG. 18 is started when the print button 311 is pressed, for example. The following descriptions will assume that the application 202 is the main entity performing this processing. However, the processing may be implemented by having another program executed by the CPU 111 for some of the processing illustrated in FIG. 18.

In step S1801, the application 202 determines whether the specific application mode is selected in the “clear coat” setting 309. The sequence moves to step S1802 if the specific application mode is determined to be selected, and to step S1806 if the specific application mode is determined not to be selected.

In step S1802, the application 202 determines whether a pixel having a predetermined pixel value is present in the image region. The predetermined pixel value is, for example, RGB values expressing white, i.e., (255, 255, 255). The sequence moves to step S1803 if a pixel having the predetermined pixel value is determined to be present, and to step S1806 if a pixel having the predetermined pixel value is determined not to be present. Pixels having a white pixel value may be detected by exhaustively checking (scanning) all pixels in the image region, for example. This processing makes it possible to perform control to skip the subsequent processing of steps S1803 to S1805 for image data that does not include pixels having a white pixel value. Note that the processing of step S1802 is not absolutely necessary, and the configuration may be such that the sequence moves to step S1803 after step S1801. In this case, if there is no white region within the image region, the sequence moves to step S1806 without the processing of step S1805 being performed.

In step S1803, the application 202 displays a message screen in the display unit 119. The message screen includes, for example, a message such as “These print settings may add a slight color white areas in the image. To cancel printing, press Cancel.”; a button that accepts an instruction to continue the printing, and a button that accepts an instruction to cancel the printing. This processing makes it possible to notify the user that the color may change prior to performing the printing.

In step S1804, the application 202 determines whether an instruction to cancel the printing processing has been received from the user. If an instruction to cancel the printing processing is determined to have been received, the processing illustrated in FIG. 18 ends, and the subsequent printing processing is not performed. On the other hand, the sequence moves to step S1805 when an instruction to cancel the printing processing is determined not to have been received. Note that the configuration may be such that the message screen displayed in step S1803 only displays the message. Steps S1805 and S1806 are executed after step S1804. Step S1805 is the same as step S602 described earlier, and will therefore not be described here. Likewise, step S1806 is the same as step S603 described earlier, and will therefore not be described here.

As described above, according to the present embodiment, the user can be notified that the color may change prior to performing the printing.

### Fourth Embodiment

A fourth embodiment will be described hereinafter, focusing on differences from the first to third embodiments. The present embodiment will describe processing performed when the image data is data in the Portable Document Format (PDF) data format (PDF data).

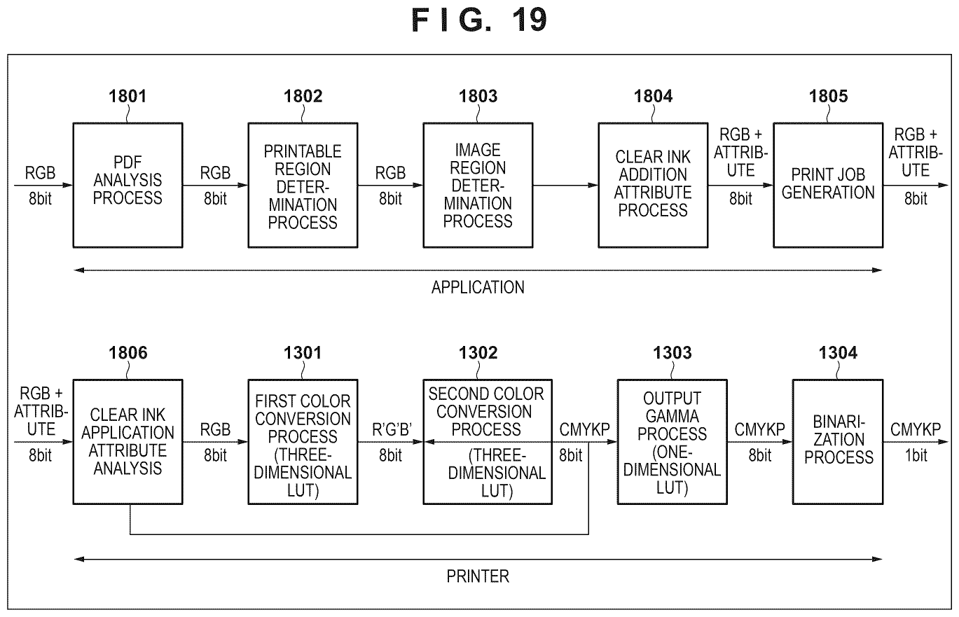

FIG. 19 is a diagram illustrating a flow in the application 202 when the application 202 is an application capable of decoding PDF data. The application 202 analyzes the PDF data in a PDF analysis process 1801. The PDF data includes rendering data information such as size information, font information, and the like for each object, such as vector data, bitmap data, and the like, as object information in the page. The application 202 analyzes the PDF data in the PDF analysis process 1801, and obtains the rendering data information as an analysis result. The application 202 then specifies the printable region on the sheet region in a printable region determination process 1802. The printable region is obtained as a region on the inside of a predetermined margin, on the basis of the specified sheet size, for example.

Next, in an image region determination process 1803, the application 202 specifies the image region in which the object is to be rendered on the basis of the analysis result obtained in the PDF analysis process 1801. For example, when borderless printing is disabled in the print setting information, a reduced image region within the printable region is specified.

Next, in a clear ink addition attribute process 1804, the application 202 sets attribute information indicating that clear ink is to be applied to the specified image region, on the basis of the result of the image region determination process 1803 and the specific application mode being selected. For example, the application 202 sets a clear ink application attribute to 1 for the specified image region. On the other hand, the application 202 sets attribute information, indicating that clear ink is not to be applied, for the margin region. For example, the application 202 sets the clear ink application attribute to 0, indicating that clear ink is not to be applied, for the margin region.

Next, in a print job generation process 1805, the application 202 generates a print job including image data in which the printable region, the image region, and the clear ink addition attribute are set. The generated print job is sent to the printing apparatus 102.

In clear ink application attribute analysis 1806, the printing apparatus 102 analyzes the clear ink addition attribute on the basis of the image data included in the received print job. Next, in the first color conversion process 1301, the printing apparatus 102 converts the image data into R′G′B′ data. Next, in the second color conversion process 1302, the printing apparatus 102 performs ink separation using the LUT for full-surface application. The LUT for the full-surface application mode provides that clear ink is also applied for white, i.e., for regions of pixels having an RGB value of (255, 255, 255). Accordingly, at this point in time, the processing is performed such that clear ink is applied to the margin region and white regions within the image region.

Next, in the output gamma process 1303, the printing apparatus 102 controls the output values of clear ink on the basis of the analysis result of the clear ink application attribute analysis 1806. Specifically, for a region where a clear ink application attribute of 1 is set, the output value of clear ink is not changed, for example. On the other hand, for a region where the clear ink application attribute is set to 0, processing is performed to set the output value to zero only for clear ink. Accordingly, processing for setting the output value of clear ink to zero is performed for the margin region, for example. On the other hand, for the image region, attribute information indicating that clear ink is to be applied is set and the output values of the clear ink are therefore kept as-is. After that, the printing apparatus 102 performs the binarization process 1304, and generates the print data.

According to the present embodiment, in the application 202, the printable region and the image region are separated using rendering data information of PDF data, and clear ink application attributes are set for each region. Such a configuration makes it possible to perform control such that clear ink is applied to the image region but not to the margin region.

Although the present embodiment describes an application capable of processing PDF data as an example, the same processing may be performed by analyzing the PDF data in the printer driver 203 or the printing apparatus 102 itself. Additionally, although the present embodiment describes a case where the data format is PDF, any other data format may be used as long as the format includes information regarding the size and position of objects, such as an XPS file, for example. Because these data formats are also used as intermediate data during rendering by the OS of the information processing apparatus 101, the printer driver 203 may obtain the rendering data information described above by obtaining and analyzing the intermediate data through the OS.

### Fifth Embodiment

A fifth embodiment will be described hereinafter, focusing on differences from the first to fourth embodiments. The present embodiment will describe processing performed when the image data is data that has been rasterized (rasterized data).

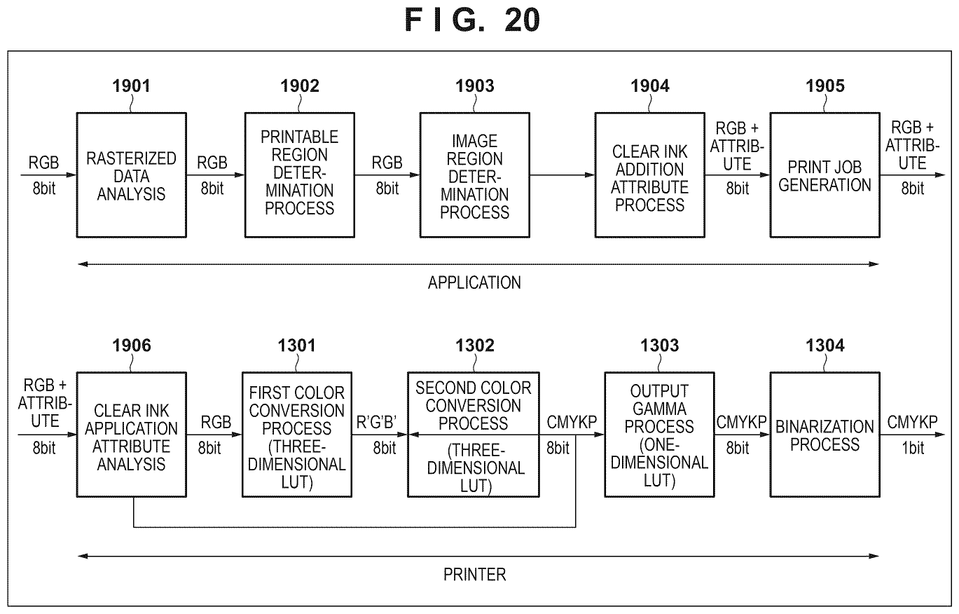

FIG. 20 is a diagram illustrating a flow in the application 202 when the image data is rasterized data. In rasterized data analysis 1901, the application 202 obtains one page's worth of rasterized data, for example. The application 202 then analyzes the rasterized data, determines white pixels and pixels of colors aside from white, and detects a pixel group, of a predetermined shape, constituted by the pixels of colors aside from white. Here, the predetermined shape is a corner shape, for example. Generally speaking, an image is often arranged as a quadrangular image region in a printable region. Accordingly, in the present embodiment, the image region is specified by detecting four pixel groups having a corner shape using a method such as pattern image detection, for example.

The application 202 then specifies the printable region on the sheet in a printable region determination process 1902. The printable region is obtained as a region on the inside of a predetermined margin, on the basis of the specified sheet size, for example.

Next, in an image region determination process 1903, the application 202 specifies the image region in which the object is to be rendered on the basis of the analysis result obtained in the rasterized data analysis 1901. Specifically, for example, the application 202 specifies a region surrounded by the four corner-shaped pixel groups detected in the rasterized data analysis 1901 as the image region. At this time, the application 202 may hold the coordinate information of the determined image region.

Next, in a clear ink addition attribute process 1904, the application 202 sets attribute information indicating that clear ink is to be applied to the specified image region, on the basis of the result of the image region determination process 1903 and the specific application mode being selected. The application 202 sets attribute information indicating that clear ink is to be applied for the specified image region. For example, the application 202 sets a clear ink application attribute to 1 for the specified image region. On the other hand, the application 202 sets attribute information, indicating that clear ink is not to be applied, for the margin region. For example, the application 202 sets the clear ink application attribute to 0, indicating that clear ink is not to be applied, for the margin region.

Next, in a print job generation process 1905, the application 202 generates a print job including image data in which the printable region, the image region, and the clear ink addition attribute are set. The generates print job is sent to the printing apparatus 102. The processing performed by the printing apparatus 102 is the same as described in the fourth embodiment, and will therefore not be described here.

According to the present embodiment, in the application 202, the printable region and the image region are separated on the basis of rasterized data, and clear ink application attributes are set for each region. Such a configuration makes it possible to perform control such that clear ink is applied to the image region but not to the margin region.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074046, filed Apr. 30, 2024, which is hereby incorporated by reference herein in its entirety.

What is claimed is:

1. A control method for an information processing apparatus, the control method comprising:
accepting a print setting operation for making a print setting for printing that is based on image data;
executing predetermined processing on the image data on the basis of the print setting made by the print setting operation including content indicating that the printing is to be executed using clear ink, the predetermined processing being processing of, among pixels included in the image data, changing at least a pixel value of a pixel corresponding to white, and not changing a pixel value of a pixel included in a margin region provided around the image data and corresponding to white; and
sending, to a printing apparatus, a print job for causing the printing apparatus to execute printing that is based on the image data on which the predetermined processing has been executed,
wherein in a case where the print setting indicated by the print job includes content indicating that the printing is to be executed using clear ink, the printing apparatus applies clear ink to a region corresponding to a pixel indicating white, and does not apply clear ink to a region corresponding to a pixel indicating a color other than white, in a printable region including a region corresponding to the image data and a region corresponding to the margin region.

2. The control method according to claim 1, further comprising:
accepting, from a user, a selection operation of selecting any one mode among a plurality of modes for executing the printing using the clear ink,
wherein the predetermined processing is controlled to be executed on the image data on the basis of the print setting made by the print setting operation including content indicating that the printing is to be executed using clear ink and the mode selected by the selection operation being a first mode among the plurality of modes, and
the predetermined processing is controlled not to be executed on the image data on the basis of the print setting made by the print setting operation including content indicating that the printing is to be executed using clear ink and the mode selected by the selection operation being a second mode, different from the first mode, among the plurality of modes.

3. The control method according to claim 2,
wherein the print job includes information indicating which mode, among the plurality of modes, is selected by the selection operation.

4. The control method according to claim 3,
wherein the second mode is a mode for applying clear ink to an entirety of the printable region,
in a case where the mode indicated by the print job is the first mode, the printing apparatus applies clear ink to the region corresponding to the pixel indicating white, and does not apply clear ink to the region corresponding to the pixel indicating a color other than white, in the printable region, and
in a case where the mode indicated by the print job is the second mode, the printing apparatus applies clear ink to the entirety of the printable region.

5. The control method according to claim 4, further comprising:
executing control such that the first mode will not be selected by the selection operation, in a case where the print setting made by the print setting operation includes content indicating that borderless printing is to be executed as the printing.

6. The control method according to claim 4,
wherein in a case where the print setting made by the print setting operation includes content indicating that borderless printing is to be executed as the printing, control is performed not to execute the predetermined processing on the image data even if the first mode is selected by the selection operation.

7. The control method according to claim 4,
wherein the predetermined processing is controlled to be executed on the image data on the basis of the print setting made by the print setting operation including content indicating that the printing is to be executed using clear ink and the mode selected by the selection operation being a third mode, different from the first mode and the second mode, among the plurality of modes, and
the third mode is a mode for, among pixels included in the image data, applying clear ink to the region corresponding to the pixel indicating white and to the region corresponding to the margin region.

8. The control method according to claim 7, further comprising:
executing control such that the third mode will not be selected by the selection operation, in a case where the print setting made by the print setting operation includes content indicating that borderless printing is to be executed as the printing.

9. The control method according to claim 2,
wherein the second mode is a mode for, among pixels included in the image data, applying clear ink to the region corresponding to the pixel indicating white and to the region corresponding to the margin region.

10. The control method according to claim 1, further comprising:
displaying an image that is based on the image data in a preview screen,
wherein even if the print setting made by the print setting operation includes content indicating that the printing is to be executed using clear ink, the image in the preview screen is displayed on the basis of image data on which the predetermined processing has not been executed.

11. The control method according to claim 1,
wherein the predetermined processing is processing for changing a pixel value of all the pixels included in the image data.

12. The control method according to claim 1,
wherein the predetermined processing is processing for changing only a pixel value of a pixel corresponding to white among the pixels included in the image data.

13. The control method according to claim 1, further comprising:
displaying a notification screen on the basis of the print setting made by the print setting operation including content indicating that the printing is to be executed using clear ink, the notification screen indicating that a pixel value of a pixel included in the image data is to be changed.

14. The control method according to claim 13,
wherein the predetermined processing is controlled to be executed on the image data on the basis of a first instruction being received from a user through the notification screen, and
the predetermined processing is controlled to not be executed on the image data on the basis of a second instruction being received from the user through the notification screen.

15. The control method according to claim 13, further comprising:
determining whether the image data includes a pixel corresponding to white, on the basis of the print setting made by the print setting operation including content indicating that the printing is to be executed using clear ink,
wherein the notification screen is controlled to be displayed on the basis of the image data being determined to include a pixel corresponding to white, and
the notification screen is controlled to not be displayed on the basis of the image data being determined not to include a pixel corresponding to white.

16. The control method according to claim 1,
wherein the printing using the clear ink is printing in which the clear ink is applied to an image printed on the basis of the image data using a printing agent other than the clear ink.

17. The control method according to claim 1,
wherein a pixel value of the pixel corresponding to white is RGB=(255, 255, 255), and
in a case where the predetermined processing is executed on the image data, among the pixels included in the image data, a pixel having a pixel value of RGB=(255, 255, 255) is converted to a pixel having a pixel value of RGB=(254, 254, 254).

18. The control method according to claim 1,
wherein the predetermined processing is processing for normalizing a RGB value such that a tone in an RGB color space is within a range from 0 to 254.

19. An information processing apparatus comprising:
at least one processor, the at least one processor:
accepting a print setting operation for making a print setting for printing that is based on image data;
executing predetermined processing on the image data on the basis of the print setting made by the print setting operation including content indicating that the printing is to be executed using clear ink, the predetermined processing being processing of, among pixels included in the image data, changing at least a pixel value of a pixel corresponding to white, and not changing a pixel value of a pixel included in a margin region provided around the image data and corresponding to white; and
sending, to a printing apparatus, a print job for causing the printing apparatus to execute printing that is based on the image data on which the predetermined processing has been executed,
wherein in a case where the print setting indicated by the print job includes content indicating that the printing is to be executed using clear ink, the printing apparatus applies clear ink to a region corresponding to a pixel indicating white, and does not apply clear ink to a region corresponding to a pixel indicating a color other than white, in a printable region including a region corresponding to the image data and a region corresponding to the margin region.

20. A storage medium having stored therein a program, the program causing an information processing apparatus to:
accept a print setting operation for making a print setting for printing that is based on image data;
execute predetermined processing on the image data on the basis of the print setting made by the print setting operation including content indicating that the printing is to be executed using clear ink, the predetermined processing being processing of, among pixels included in the image data, changing at least a pixel value of a pixel corresponding to white, and not changing a pixel value of a pixel included in a margin region provided around the image data and corresponding to white; and
send, to a printing apparatus, a print job for causing the printing apparatus to execute printing that is based on the image data on which the predetermined processing has been executed,
wherein in a case where the print setting indicated by the print job includes content indicating that the printing is to be executed using clear ink, the printing apparatus applies clear ink to a region corresponding to a pixel indicating white, and does not apply clear ink to a region corresponding to a pixel indicating a color other than white, in a printable region including a region corresponding to the image data and a region corresponding to the margin region.
